(19) United States
(12) Patent Application Publication
(10) Pub. No.: US 2024/0067032 A1
(43) Pub. Date: Feb. 29, 2024

(54) REMOTELY ACCESSIBLE SYSTEM FOR DERIVING COMPONENT STATES VIA A CHARGING SOCKET

(71) Applicant: Robert Bosch GmbH, Stuttgart (DE)

(72) Inventor: Jens Konczak, Reppenstedt (DE)

(21) Appl. No.: 18/262,358

(22) PCT Filed: Nov. 24, 2021
(86) PCT No.: PCT/EP2021/082786

§ 371 Date: Jul. 20, 2023

(30) Foreign Application Priority Data
Dec. 10, 2020 (DE) 10 2020 215 606.9

(51) Int. Cl. B60L 53/66; B60L 53/16; B60L 53/18; B60L 53/65; H02J 7/00

(52) U.S. Cl. CPC B60L 53/66; B60L 53/16; B60L 53/18; B60L 53/65; H02J 7/00032; B60L 2240/545

(57) ABSTRACT

The invention relates to a method for transmitting vehicle information during a charging situation of an electric vehicle (100) at a charging station (300) by means of a charging socket (220) which contains a dongle (230) which comprises evaluation electronics (240) and contains a transmission device (250) and an energy supply (260), wherein the method comprises at least the following method steps:
First, the charging socket (220) of a charging cable (200) is connected to the vehicle-side charging plug (110) of the electric vehicle (100). A cable-side charging plug (210) is then connected to a mains-side charging socket (310) of a charging station (300). A signal analysis is then carried out by means of the evaluation electronics (240). A specific signal is then generated when the signal analysis indicates that an examined parameter is at a target value or that this target value is not present within a specific time period or is entirely absent. This is followed by a transmission of vehicle information when the specific signal is present at the dongle (230) within the specific time frame or is entirely absent.

### BACKGROUND

The invention relates to a method of transmitting vehicle information using a charging plug, an electric vehicle, and a charging socket, wherein the charging plug comprises a dongle and the electric vehicle comprises evaluation electronics. Furthermore, the present invention relates to a charging plug for an electric vehicle, wherein the charging plug comprises a dongle and the dongle comprises a means for detecting the presence of a specific signal, as well as a means for enabling the transmission of vehicle information of the electric vehicle and/or for enabling the charging process. Furthermore, the invention relates to an electric vehicle comprising a charging plug with a dongle.

Electric vehicles require periodic charging. The batteries are often a weak area. Especially if they have undetected defects, they can cause significant damage ranging from thermal development, up to fires. Before connecting a battery to the mains, it should therefore be checked whether the battery is fully functional or damaged.

With the vehicle in motion, the vehicle parameters are permanently monitored by the on-board electronics. When the vehicle is stationary, the vehicle data can be read by technical personnel via the on-board computer of the vehicle. Using the on-board computer for diagnostics before each charging operation is costly and carries the risk of forgetting or just spot-checking. In the parked (sealed) vehicle, as well as during a charging operation, during which the vehicle is also usually closed, vehicle diagnostics are not performed because the on-board vehicle diagnostic systems as a rule are also switched off and thus at rest when the ignition is switched off.

Methods, for example radio communications, with which vehicles can communicate with external devices, for example those of mechatronic personnel, are known from the prior art. For example, such radio networks can be implemented as a wide area network (WAN) or a global system for mobile communications (GSM).

### SUMMARY

The invention relates to a method for transmitting vehicle information during a charging situation at a charging station by means of a charging socket of an electric vehicle, wherein the charging socket includes a dongle that comprises evaluation electronics, a transmission device and an energy supply, and the following method steps are to be passed through:

connecting the charging socket of a charging cable to a vehicle-side charging plug of the electric vehicle;

connecting a cable-side charging plug to a mains-side charging socket of a charging station;

carrying out signal analysis by the evaluation electronics;

generating a specific signal when the signal analysis indicates that an examined parameter is at a target value or that this target value is not present within a specific time period or is entirely absent;

transmitting vehicle information when the specific signal is present at the dongle within the specific time frame or is entirely absent.

In a further aspect of the solution proposed according to the present invention, a method of transmitting vehicle information is proposed, during a parking or transport situation of an electric vehicle remotely from a charging station by means of a charging socket, which includes a dongle, evaluation electronics, a transmission device and an energy supply, wherein the method comprises the following steps:
connecting the charging socket to a vehicle-side charging plug of the electric vehicle;
simulation of a signal level of a connected charging station by the dongle;
carrying out signal analysis by the evaluation electronics;
generating a specific signal when the signal analysis indicates that an examined parameter is at a target value or that this target value is not present within a specific time period or is entirely absent;
transmitting vehicle information when the specific signal is present at the dongle within the specific time frame or is entirely absent.

In a third aspect of the method proposed according to the present invention, this serves to transmit vehicle information for theft protection or to detect unauthorized access to an electric vehicle with a charging socket which includes a dongle that contains evaluation electronics, a transmission device and an energy supply, wherein the following method steps are passed through:
connecting the charging socket to a vehicle-side charging plug of the electric vehicle;
removing the charging socket from the vehicle-side charging plug of the electric vehicle;
carrying out signal analysis by the evaluation electronics;
generating a specific signal when the signal analysis indicates that the charging socket has been removed from the vehicle-side charging plug of the electric vehicle;
transmitting vehicle information and position information when the specific signal is present within the specific time frame.

In the context of this invention, all types of motor vehicles that are electrically or at least partially electrically operated, so-called hybrid vehicles, are referred to as an electric vehicle. Electrically or partially electrically powered cars, trucks, buses or watercraft are therefore referred to in particular as electric vehicles. In the following context, a dongle is understood to mean a device that provides intelligence in evaluation electronics with an integrated storage medium, further comprises transmitting and receiving capabilities within the scope of a transmission device, and further comprises a device for positioning, for example a GPS system and an energy supply.

Electric vehicles require an internal energy source to operate their electric motor; this is implemented as a battery. The battery can be charged via a connection to external mains. This connection is implemented by a vehicle-side charging plug, a charging socket of a charging cable and a mains-side charging socket at a charging station, in which the charging socket is inserted into the vehicle-side charging plug and the charging plug of the charging cable is inserted into the mains-side charging socket of the charging station. Such a connection can be implemented via a standardized type 2 plug and socket pair, for example.

In the context of this invention, the charging socket is a socket of a charging cable of a charging station, a 130 V to 250 V socket, and a stand-alone socket without a cable, respectively. It is important that the charging socket can be used to charge the electric vehicle or simulate charging via the stand-alone socket with the integrated dongle by means of corresponding signaling.

A dongle is a so-called copy protection plug or hardware key that is used to protect software or data from unauthorized access. A dongle is generally capable of enabling access to a particular software or data when predetermined conditions occur, such as exchanging a particular protocol, receiving a specific signal or data, in particular a digital key or digital signature.

In the context of the present invention, within a first aspect (charging situation at a charging station), the dongle evaluates signals from the on-board charger or the on-board computer and transmits vehicle data under certain set circumstances. Within a second aspect, i.e. during a parking or transport situation of the electric vehicle, the dongle simulates the charging situation at a charging station and thereby stimulates the in-vehicle evaluation electronics or the on-board charger. In certain set circumstances, vehicle information is also sent to defined recipients here.

In the context of a third aspect of the present invention, namely as theft protection or to detect unauthorized access to an electric vehicle, the generation of a specific signal follows when a signal analysis determines that the charging socket has been removed from the vehicle-side charging plug of the electric vehicle. In this case, when the specific signal is present within the particular time period, vehicle information and location information will be determined.

Electric vehicles using the method according to the present invention further require evaluation electronics designed to determine at least one status parameter (battery status of readiness to→charge) of the vehicle. For example, the evaluation electronics can be implemented as part of the on-board software of the on-board computer of the electric vehicle, or as an additional module in the electric vehicle.

The examined parameter has a target value when the evaluation electronics determine that a measured value is within a certain range of measurements or that the value is above or below a threshold value, depending on which value is to be determined or which parameter is to be examined.

To initiate the method according to the invention, the electric vehicle is connected to the charging station with the vehicle-side charging plug, the charging socket, the charging cable and the mains-side charging socket. This can be done, for example, by manually inserting the charging plug into the charging socket.

The dongle simulates the connection to a charging station to the vehicle-side evaluation electronics with voltage levels, for example 12 V or 9 V. The vehicle diagnostics are thereby activated and performed by the evaluation electronics. When the examined parameter reaches a target value, a signal, in particular from the evaluation electronics, is generated, which is then received and interpreted by the dongle. The dongle checks whether the generated signal, for example a 6 V voltage level, is present within a specific time period or is entirely absent, and, if the signal is present within a specific time period, enables access to software that initiates and/or performs the transmission of the vehicle information.

Preferably, a battery of the electric vehicle is not charged until the evaluation electronics of the vehicle determine that the battery is undamaged and/or sends back a status that indicates that the battery is ready for operation.

In an advantageous embodiment variant of the method proposed according to the invention, the vehicle information comprises status information of a battery, in particular the traction battery, also known as a driving battery, of the electric vehicle. For example, the status information can comprise information about the status of the battery as a whole or about individual cells of the battery, such as the status of charging, the charging capacity, output power, or similar parameters that characterize the status of a battery or portions thereof.

In a further advantageous embodiment variant, the thermal state, in particular the temperature of the battery, is determined during vehicle diagnostics. If the battery becomes too warm during charging, the heat generated can cause damage to the battery or the vehicle.

In one embodiment, the vehicle information comprises the location, particularly the GPS location and/or the chassis number of the electric vehicle.

In one advantageous embodiment, the specific signal is a standard 6 V signal.

In another embodiment, the vehicle information is transmitted periodically, within a querying interval, and/or in response to a querying ping.

In one embodiment variant, the vehicle information is transmitted via a radio network.

In another embodiment, the radio network is a wide area network (WAN) or a global standard for mobile communications (GSM) network.

In a further aspect, the invention relates to a charging socket of an electric vehicle comprising a dongle. The dongle in turn comprises a means for detecting the presence of a specific signal and a means for enabling transmission of vehicle information of the electric vehicle.

Finally, the invention relates to an electric vehicle comprising a dongle described above, as well as means for carrying out the method described above. The means for carrying out the method described above can comprise, for example, the evaluation unit and a transmission unit, in particular an antenna and its controls.

### Advantages of the Invention

Access to the vehicle information is simplified by the method according to the invention, since each electric vehicle must be charged sooner or later and the charging socket of the electric vehicle is connected to a charging plug for this purpose. The method is then automatically performed and the parameter to be examined is checked. Using this method, the vehicle can transmit the examined parameter during each charging operation, which allows for regular and frequent monitoring of the vehicle without needing to query the on-board computer and/or the evaluation electronics manually with major effort.

Advantageously, communicating the status information of the battery allows the battery to be monitored periodically. This can detect a failure of the battery early on and avoid its failure or unforeseen degradation in performance.

Determining the thermal state and in particular the temperature of the battery and communicating the corresponding status information of the battery can be used to detect heat generation early and mitigate the risk of damage from a fire. For electric vehicles in particular, it is therefore of great interest to know the thermal status of the battery, in particular the traction battery, at all times.

By transmitting the location and/or the chassis number, the manufacturer of the electric vehicle is enabled to monitor important vehicle data after exiting the production line until it is handed over to the customer. In particular, the manufacturer can monitor the data remotely. For example, the battery status can be indirectly determined and communicated along with location data. Thus, the manufacturer always knows which of his manufactured vehicles are where and with which battery status. By associating the chassis number, the owner of the vehicle, including both the manufacturer and the manufacturer's customers, would be enabled to permanently monitor the electric vehicle in its parking position (during charging). In particular, manufacturers can thereby quickly identify certain vehicles based on their chassis number and locate them on the plant premises.

In connection with the transmission of the battery status, in particular the thermal status of the battery, the owner of the vehicle, in particular dealerships whose sales premises can have multiple electric vehicles, can quickly locate the vehicle and avoid damage independently of an indirect fire detection infrastructure, such as fire detectors, cameras, etc. Further, by transmitting the location, the vehicle can be located with each charging operation, making it easier to find again after theft.

The vehicle information is thus transmitted continuously in an advantageous manner, not only after the insertion of the charging plug into the socket, but continuously thereafter at freely selectable intervals during the charging process. As a result, a defect that arises only during the charging process, in particular a defect of the battery or portions thereof, can also be detected early.

Advantageously, the vehicle information can thus be transmitted to any location with a connection to the respective radio network. The method can thereby be used remotely.

Both WAN and GSM technology are standardized and can be easily used in the charging sockets and dongles, respectively. The network can further extend across a region, for example a city, a particular terrain, particularly plant premises, a single building, for example a showroom or exhibition hall, or a large area, particularly the planet. Further, the network can be locally restricted and limited by a local area network (LAN), in particular a wireless local area network (WLAN).

The signal to be detected is preferably the signal, in particular the 6 V signal, of an evaluation unit of the electric vehicle. For example, the means for enabling transmission of vehicle information can include program code which controls a controller so that it sends a signal to a transmission unit, in particular an antenna and its control unit, whereupon said controller transmits the vehicle information.

In order to move an electric vehicle, the charging socket must first be removed. In order to ensure that this is not forgotten and the vehicle, charging cable and charging station are not damaged, driving with the charging socket inserted is not possible. The method proposed according to the invention enables the owner of the electric vehicle, which includes both the manufacturer and the customers of the manufacturer, transport companies, workshops, etc. to register the removal of the charging socket at any time, and enables them to register unauthorized movements, such as theft of the vehicle. In addition to the vehicle information, its location data can also be advantageously transmitted, so that the possibly stolen or unauthorized vehicle can be located with respect to its current location.

### BRIEF DESCRIPTION OF THE DRAWINGS

Embodiments of the invention are explained in greater detail with reference to the drawings and the following description.

Shown in the drawings are:

FIG. 1a in a schematic diagram, shows the procedure of the method of an embodiment in the event: charging situation at a charging station,

FIG. 1b in a schematic diagram, shows the procedure of the method in a second embodiment variant: Electric vehicle remote from a charging station (parking situation, transportation, . . . ),

FIG. 2a in a schematic diagram, shows the procedure of the method in an embodiment variant: vehicle location during a charging situation,

FIG. 2b in a schematic diagram, shows the procedure of the method in an embodiment variant: Electric vehicle remote from a charging station (parking situation, transportation, . . . ), and

FIG. 3 shows the assignment of the contacts of a type 2 plug.

### DETAILED DESCRIPTION

In the following description of the embodiments of the invention, identical or similar elements are denoted by identical reference numbers, wherein a repeated description of these elements is omitted in individual cases. The figures illustrate the subject matter of the invention merely schematically.

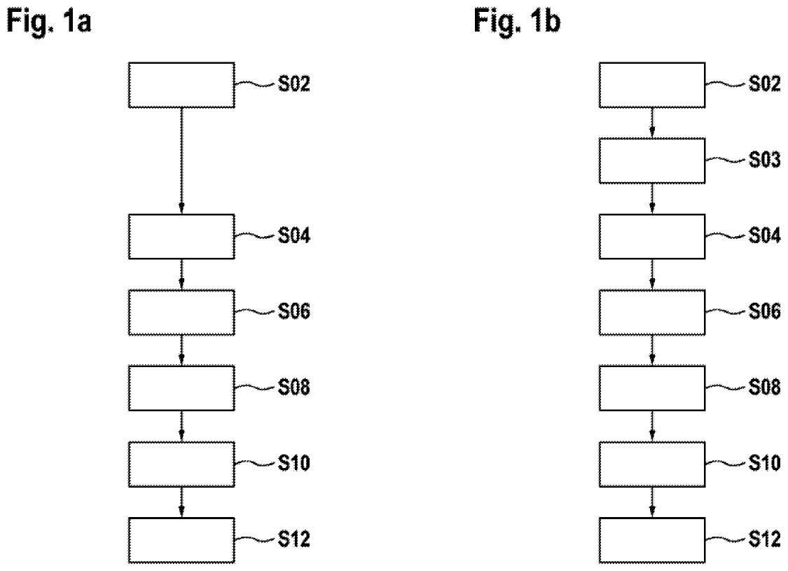

FIG. 1a shows the procedure of the method proposed according to the invention according to a first embodiment variant during a charging operation at a charging station 300. The method begins with step S02, in which a charging socket 220 is connected to a vehicle-side charging plug 110. In step S04, on-board electronics of the electric vehicle 100 optionally detect the charging column by in-vehicle evaluation electronics 240 (on-board computer 140) or an on-board charger 120 (OBC) or a plug contact, or by applying a voltage level, for example in the form of a 12 V signal. The voltage level is changed while the charging socket 220 is plugged in, for example to a 9 V voltage level. In step S06, the evaluation electronics 240 (on-board computer 140) perform a signal analysis and generate a signal in step S08 if the signal analysis determines that a parameter examined in the signal analysis has a target value—depending on the type of parameter—or that this is absent or not found within a period of time, or exceeds or falls below a threshold value.

In step S10, it is verified whether the signal is present at a dongle 230 within the cable-side charging socket 210 within a certain period of time, or not. If this is the case, or not the case, the dongle 230 will transmit vehicle information and/or GPS location of the electric vehicle 100 in step S12, preferably via a radio network, for example via GSM or a WAN, in particular a Low Power Wide Area Network (LoRa-WAN or LPWAN).

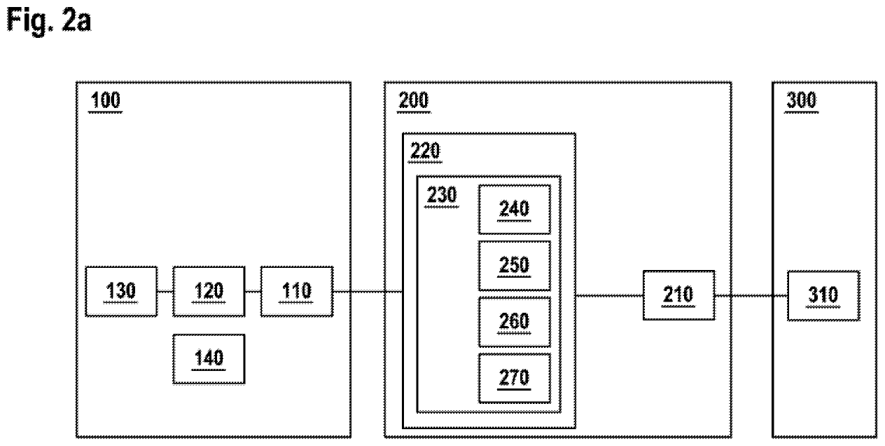

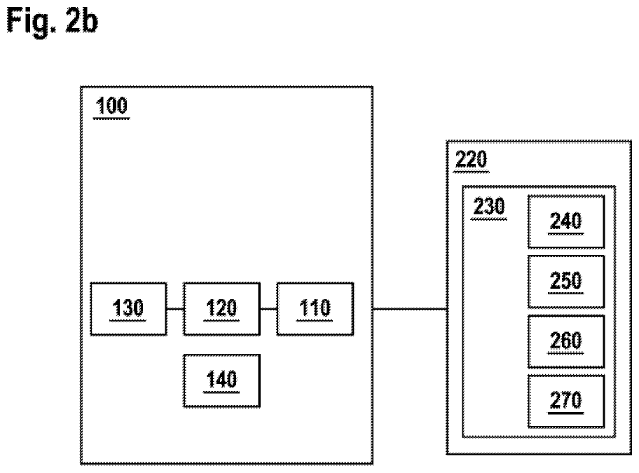

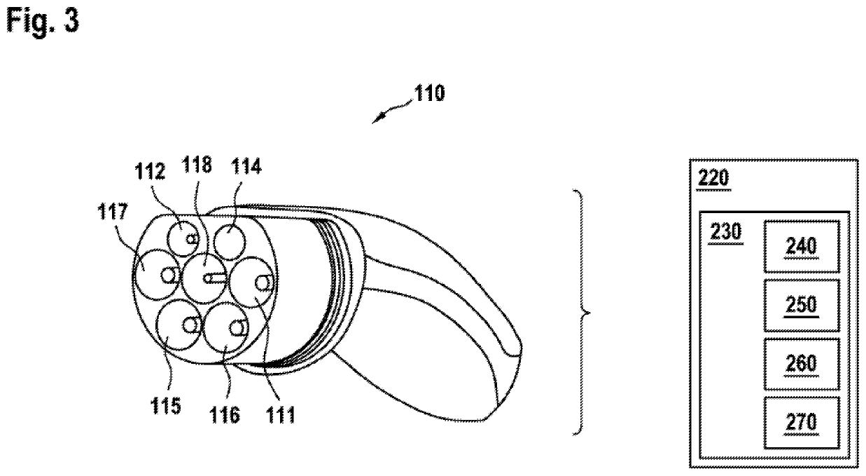

The diagram according to FIG. 1b shows the procedure of a further embodiment variant of the method proposed according to the invention in which the electric vehicle 100 is in a parking or transport situation remotely from a charging station 300. The method begins with step S02, in which an autonomous dongle 230 is connected to an on-board charging plug 110 of the electric vehicle 100, as shown in FIG. 2b, FIG. 3. In step S03, the autonomous dongle 230 simulates the signal structure of a charging station 300 by means of its integrated intelligence. The on-board electronics, for example the on-board computer 140 of the electric vehicle 100, detect the charging station 300 simulated by the inserted autonomous dongle 230 in step S04, optionally by in-vehicle evaluation electronics 240 or an on-board charger 120 (OBC). Alternatively, a plug contact or the application of a voltage level, for example a 12 V signal, can be simulated. The voltage level is changed when the signal is present, for example from a 12 V signal to a 9 V signal, or a corresponding voltage level. In step S06, the evaluation electronics 240. that is, the on-board computer 140 of the electric vehicle 100, perform a signal analysis and generate a signal in step S08 if the signal analysis determines that a parameter examined in the signal analysis has a target value—depending on the type of parameter—or that this is absent or not found within a period of time, or exceeds or falls below a threshold value.

In step S10, it is checked whether the signal is present at a dongle 230 within the vehicle-side charging plug 110 within a certain period of time, or not. If this is the case, or not the case, the dongle 230 will transmit vehicle information and/or GPS location in step S12, preferably via a radio network, for example via GSM or a WAN, in particular a Low Power Wide Area Network (LoRa-WAN or LPWAN). This allows the exact position of an electric vehicle 100 which is used without authorization, for example, or stolen, to be located within the shortest possible time, so that effective theft protection and/or a locating option for an electric vehicle 100 is provided by the method proposed according to the invention.

FIG. 2a shows the schematic structure of an electric vehicle 100, including its infrastructure components required for the execution of the method proposed according to the invention according to the three embodiment variants. The electric vehicle 100 includes a vehicle-side charging plug 110, which can be connected to a charging socket 220 of a charging cable 200 and, for example, a mains-side charging socket 310 of a charging station 300 for a charging operation. A dongle 230 is placed within the charging socket 220. The dongle 230 itself comprises evaluation electronics 240, a transmission device 250 for receiving and transmitting signals, an autonomous energy supply 260, and a device 270 for determining the position, for example via GPS.

If the on-board charger 120 (OBC) of the electric vehicle 100 detects that the charging socket 220 is inserted and a cable-side charging plug 210 is connected to the mains-side charging socket 310 of the charging station 300, at least one parameter of the electric vehicle 100, for example of the battery 130, is checked via the on-board computer 140. For example, the parameter can be the status, particularly the thermal status of a battery 130, of the electric vehicle 100.

When the battery 130 is operational, a signal, such as a 6 V voltage level, is sent to the charging station 300, and the charging process of the battery 130 can begin. If this voltage level, for example the 6 V signal, is not sent, or is not transmitted within a certain time period, this circumstance is detected via the evaluation electronics 240 integrated in the dongle 230. The transmission device 250, which comprises a GSM module or a WAN antenna, for example, is actuated by the evaluation electronics 240 to transmit the vehicle information. Specifically, the vehicle information can include the determined status of the battery 130, the chassis number of the electric vehicle 100, and/or the current location of the electric vehicle 100.

While the charging socket 220 is part of the charging cable 200 and comprises the dongle 230 integrated into the charging socket 220 in the embodiment variant according to FIG. 2a, the charging socket 220 is built as an autonomous unit in the embodiment variant according to FIG. 2b, and also contains the dongle 230. The embodiment variants of the dongle 230 of the charging socket 220 are the same in both embodiment variants according to FIGS. 2a and 2b. The difference between FIGS. 2a and 2b is that in the embodiment variant according to FIG. 2a, the charging cable 200 with its cable-side charging plug 210 is inserted into the mains-side charging socket 310 of the charging station 300. The charging station 300, including the mains-side charging socket 310, is missing in the embodiment variant according to FIG. 2b. In the embodiment variant according to FIG. 2b, the charging station 300 is simulated by the charging socket 220 inserted into the vehicle-side charging plug 110, including the dongle 230.

FIG. 3 shows the assignment of the contacts of a type 2 plug. The type 2 plug corresponding to a vehicle-side charging plug 110 includes a neutral conductor 111, a proximity pilot 112, a control pilot 114, phase conductor contacts 115, 116 and 117, and a ground contact 118.

The invention is not limited to the embodiment examples described here and the aspects highlighted therein. Rather, within the range specified by the claims, a large number of modifications are possible which lie within the abilities of a skilled person.

1. A method for transmitting vehicle information during a charging situation of an electric vehicle (100) at a charging station (300), via a charging socket (220) including a dongle (230) comprising evaluation electronics (240), a transmission device (250), and an energy supply (260), wherein the method comprises the steps of:
a. connecting the charging socket (220) of a charging cable (200) to a vehicle-side charging plug (110) of the electric vehicle (100);
b. connecting a cable-side charging plug (210) to a mains-side charging socket (310) of a charging station (300);
c. carrying out signal analysis by the evaluation electronics (240);
d. generating a specific signal when the signal analysis indicates that an examined parameter is at a target value or that this target value is not present within a specific time period or is entirely absent; and
e. transmitting vehicle information when the specific signal is present at the dongle (230) within the specific time frame or is entirely absent.

2. A method for transmitting vehicle information during a parking or transport situation of an electric vehicle (100) remotely from a charging station (300) by means of a charging socket (220) including a dongle (230) containing evaluation electronics (240), a transmission device (250), and an energy supply (260), wherein the method comprises the steps of:
a. connecting the charging socket (220) to a vehicle-side charging plug (110) of the electric vehicle (100);
b. simulation of a signal level of a connected charging station (300) by the dongle (230);
c. carrying out signal analysis by the evaluation electronics (240);
d. generating a specific signal when the signal analysis indicates that an examined parameter is at a target value or that this target value is not present within a specific time period or is entirely absent; and
e. transmitting vehicle information when the specific signal is present at the dongle (230) within the specific time frame or is entirely absent.

3. A method for transmitting vehicle information to protect against theft or detect unauthorized access to an electric vehicle (100) by way of a charging socket (220) including a dongle (230) that comprises evaluation electronics (240), a transmission device (250), and an energy supply (260), wherein the method comprises the steps of:
a. connecting the charging socket (220) to the vehicle-side charging plug (110) of the electric vehicle (100),
b. removing the charging socket (220) from the vehicle-side charging plug (110) of the electric vehicle (100);
c. carrying out signal analysis by the evaluation electronics (240);
d. generating a specific signal when the signal analysis determines that the charging socket (220) has been removed from the vehicle-side charging plug (110) of the electric vehicle (100); and
e. transmitting vehicle information and position information when the specific signal is present within the specific time frame.

4. The method according to claim 1, wherein the vehicle information comprises status information of a battery (130) of the electric vehicle (100), in particular the traction battery or portions thereof.

5. The method according to claim 1, wherein the signal analysis directly or indirectly determines a thermal state, in particular the temperature, of the battery (130) and/or portions thereof.

6. The method according to claim 1, wherein the vehicle information comprises the location, particularly the GPS location, and/or the chassis number of the electric vehicle (100).

7. The method according to claim 1, wherein, characterized in that the specific signal is a 6 V signal.

8. The method according to claim 1, wherein the vehicle information is transmitted periodically, within a querying interval, and/or in response to a querying ping.

9. The method according to claim 1, wherein the vehicle information is transmitted over a radio network.

10. The method according to claim 9, wherein the radio network is a WAN or GSM network.

11. A charging socket (220) of an electric vehicle (100), wherein the charging socket (220) comprises a dongle (230), wherein the dongle (230) comprises a means for detecting the presence of a specific signal, and a means for enabling transmission of vehicle information of the electric vehicle (100).

12. A charging cable (200) with a charging socket (220) according to claim 11.

13. An electric vehicle (100) comprising a charging socket (220) with a dongle (230), wherein the dongle (230) comprises a means for detecting the presence of a specific signal, and a means for enabling transmission of vehicle information of the electric vehicle (100), and wherein the electric vehicle (100) comprises means for
a. connecting the charging socket (220) of a charging cable (200) to a vehicle-side charging plug (110) of the electric vehicle (100);
b. connecting a cable-side charging plug (210) to a mains-side charging socket (310) of a charging station (300);
c. carrying out signal analysis by the evaluation electronics (240);
d. generating a specific signal when the signal analysis indicates that an examined parameter is at a target value or that this target value is not present within a specific time period or is entirely absent; and
e. transmitting vehicle information when the specific signal is present at the dongle (230) within the specific time frame or is entirely absent.
